(19) United States
(12) Patent Application Publication
(10) Pub. No.: US 2026/0296193 A1
(43) Pub. Date: Oct. 1, 2026

(54) VEHICLE, PLACEMENT METHOD FOR CAPTURING APPARATUS, AND STORAGE MEDIUM

(71) Applicant: HONDA MOTOR CO., LTD., Tokyo (JP)

(72) Inventor: Kenta Maruyama, Tokyo (JP)

(21) Appl. No.: 19/467,006

(22) Filed: Feb. 2, 2026

(30) Foreign Application Priority Data
Mar. 28, 2025 (JP) 2025-056378

(51) Int. Cl. B60K 35/28; G06T 7/70; G06V 20/59; G06V 40/10

(52) U.S. Cl. CPC B60K 35/28; G06T 7/70; G06V 20/59; G06V 40/10; B60K 2360/176; B60K 2360/195; B60K 2360/589; G06T 2207/30196; G06T 2207/30268

(57) ABSTRACT

A vehicle including a touch panel, and a first control section that acquires a captured image captured by a streamer terminal and displays the acquired captured image on the touch panel, wherein the first control section displays, on the touch panel, a guide image for guiding placement of the streamer terminal in the vehicle based on the captured image.

### INCORPORATION BY REFERENCE

The present application claims priority under 35 U.S.C. § 119 to Japanese Patent Application No. 2025-056378 filed on Mar. 28, 2025. The content of the application is incorporated herein by reference in its entirety.

### BACKGROUND OF THE INVENTION

### Field of the Invention

The present invention relates to a vehicle, a placement method for a capturing apparatus, and a storage medium.

In recent years, efforts have been accelerating to provide access to sustainable transportation systems that take into account vulnerable traffic participants such as the elderly, people with disabilities, and children. To this end, efforts are focused on research and development for further improving the safety and convenience of traffic through the development of means of transportation for vulnerable road users.

Japanese Patent Laid-Open No. 2016-145864 discloses a vehicle display apparatus including a display part that displays vehicle information to a vehicle passenger, a connection unit that is communicably connected to a portable terminal including a portable display part, and a control unit that performs display control of the display part.

When capturing a state of an inside of the vehicle using a camera such as that of a smartphone and streaming a captured image as a streaming image, there is a problem that the camera needs to be placed taking into consideration angle of view and the like, which complicates placement of the camera in the vehicle. The present invention was made in view of the above-described circumstances and has an object to assist placement of a capturing apparatus in a vehicle and to enhance ease of placement.

The present invention was made in view of the above-described circumstances and has an object to assist placement of a capturing apparatus in a vehicle and to enhance ease of placement. Therefore, through a service for connecting remote locations and vehicles, the present invention contributes to supporting good connection between urban areas and regional areas such as those surrounding urban areas, and to the development of sustainable transportation systems.

### SUMMARY OF THE INVENTION

A vehicle according to an aspect of the present disclosure is a vehicle including: an in-vehicle display apparatus; and a control apparatus configured to acquire a captured image captured by a capturing apparatus and display the acquired captured image on the in-vehicle display apparatus, wherein the control apparatus displays, on the in-vehicle display apparatus, a guide image for guiding placement of the capturing apparatus in the vehicle based on the captured image.

According to the present disclosure, the guide image for guiding placement of the capturing apparatus in the vehicle based on the captured image acquired from the capturing apparatus is displayed on the in-vehicle display apparatus. Accordingly, it is possible for a user to place the capturing apparatus in the vehicle while referencing the guide image displayed on the in-vehicle display apparatus, to simplify placement work of the capturing apparatus, and to enhance user-friendliness.

### BRIEF DESCRIPTION OF THE DRAWINGS

FIG. 1 is a diagram showing a system configuration of a streaming system;

FIG. 2 is a block diagram showing a configuration of an in-vehicle apparatus and a streaming server;

FIG. 3 is a diagram showing an attachment example of a streamer terminal in a vehicle;

FIG. 4 is a diagram showing an attachment example of the streamer terminal in the vehicle;

FIG. 5 is a diagram showing a configuration of a user information DB;

FIG. 6 is a diagram showing a configuration of a stream management DB;

FIG. 7 is a block diagram showing a configuration of the streamer terminal and a viewer terminal;

FIG. 8 is a diagram showing an example of a guide image; and

FIG. 9 is a flowchart showing an operation of an in-vehicle apparatus.

### DETAILED DESCRIPTION OF THE INVENTION

Hereinafter, an embodiment of the present invention will be described with reference to the drawings.

### Embodiment 1

### 1. Configuration of Streaming System

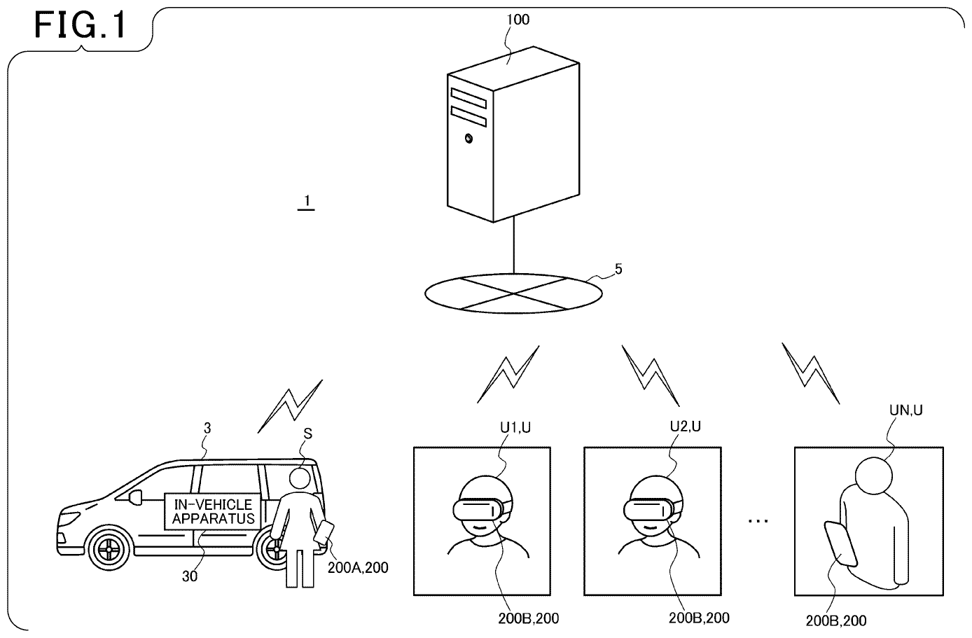

FIG. 1 is a diagram showing a system configuration of a streaming system 1.

The streaming system 1 includes an in-vehicle apparatus 30, a streamer terminal 200A, a streaming server 100, and a viewer terminal 200B. The streaming system 1 is a system for live streaming content including an image captured by the streamer terminal 200A.

Live streaming refers to an activity in which a streamer and an unspecified viewer participate, and an image based on a capturing result from the streamer terminal 200A is streamed in real-time to the viewer terminal 200B. The image may be a still image or a moving image.

The in-vehicle apparatus 30 is installed in a vehicle 3 and is wirelessly connected via short-range wireless communication or the like to the streamer terminal 200A possessed by a streamer S being a passenger of the vehicle 3.

The in-vehicle apparatus 30 receives, from the streamer terminal 200A, content data including an image captured by a camera included in the streamer terminal 200A and speech input via a microphone included in the streamer terminal 200A. The in-vehicle apparatus 30 uploads the received content data to the streaming server 100.

The streamer terminal 200A may be a smartphone or tablet personal computer (PC), or may be a camera such as a digital camera or a 360-degree camera capable of capturing an entire surrounding area. In this case, the microphone and the camera may be implemented separately. The streamer terminal 200A corresponds to a capturing apparatus.

The streaming server 100 stores the content data received from the in-vehicle apparatus 30 in a server storage unit. The streaming server 100 streams the uploaded content data to the viewer terminal 200B of a viewer U. Live streaming technology can be realized using known technology such as HTTP Live Streaming (HLS), Common Media Application Format (CMAF), Web Real-Time Communication (WebRTC), or Real-Time Messaging Protocol (RTMP).

The viewer terminal 200B is a terminal apparatus possessed by the viewer U that views the content data streamed from the streaming server 100. FIG. 1 shows U1, U2, . . . , UN viewers U as the viewer U. N is an arbitrary natural number.

For example, the viewer terminal 200B may be a portable or mobile terminal apparatus such as a smartphone, tablet PC, or notebook PC, or may be a stationary terminal apparatus such as a desktop PC. The viewer terminal 200B may be a television set, or a head-mounted display apparatus in which an image display part is mounted on the head of the viewer U and a display included in the image display part is arranged in front of the eyes of the viewer U. The head-mounted display apparatus may be transmissive or non-transmissive, as long as the content streamed from the streaming server 100 can be viewed.

Hereinafter, the streamer terminal 200A and the viewer terminal 200B will be notated as a terminal apparatus 200 when collectively referring thereto.

A communication network 5 is a wired or wireless transmission path for information transmitted from an apparatus connected to the communication network 5. For example, the communication network 5 may include a public network such as the Internet, a mobile communication network, a satellite communication network, or various local area networks (LANs) including Ethernet (registered trademark) or a wide area network (WAN). The communication network 5 may include a dedicated network such as an Internet protocol-virtual private network (IP-VPN).

### 2. Configuration of In-Vehicle Apparatus

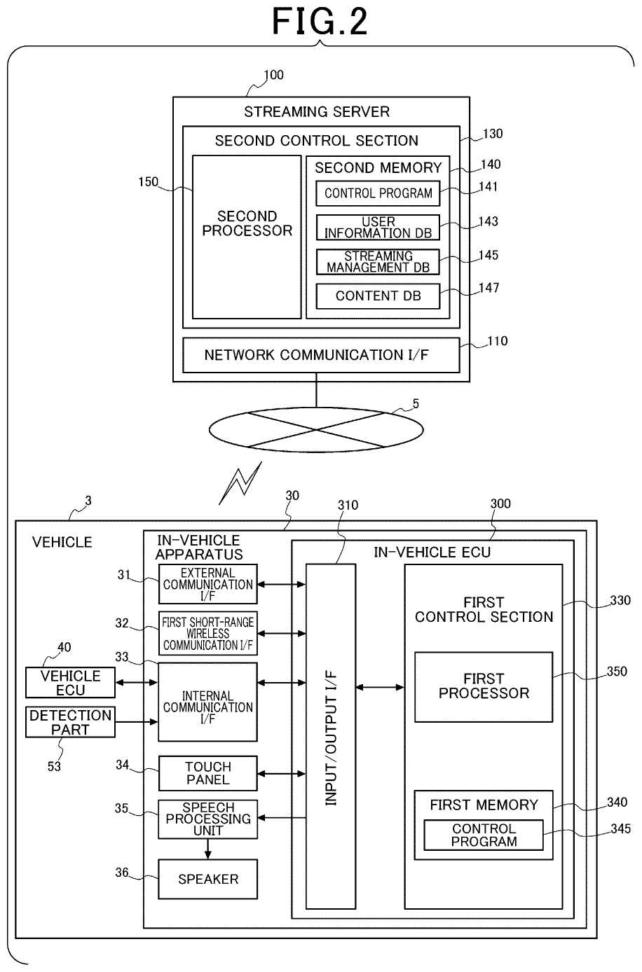

FIG. 2 is a diagram showing a configuration of the in-vehicle apparatus 30 and the streaming server 100.

First, the configuration of the in-vehicle apparatus 30 will be described with reference to FIG. 2.

The in-vehicle apparatus 30 includes an external communication interface 31, a first short-range wireless communication interface 32, an internal communication interface 33, a touch panel 34, a speech processing unit 35, a speaker 36, and an in-vehicle electronic control unit (ECU) 300. Hereinafter, interface will be abbreviated as I/F.

The external communication I/F 31 is a communication module that performs wireless communication in accordance with a mobile communication standard such as long-term evolution (LTE), fourth-generation (4G), 5G, or Wi-Fi (registered trademark). The external communication I/F 31 is connected to the communication network 5 via an antenna (not shown) and performs mutual data transmission/reception with the streaming server 100. The external communication I/F 31 corresponds to a communication apparatus.

For example, the first short-range wireless communication I/F 32 is a communication module that performs communication in accordance with a near-field communication (NFC) standard such as Bluetooth (registered trademark) or Wi-Fi. The first short-range wireless communication I/F 32 performs short-range wireless communication with the streamer terminal 200A possessed by the streamer S and receives an image captured by the streamer terminal 200A, speech input from the streamer terminal 200A, and the like. The first short-range wireless communication I/F 32 corresponds to a wireless communication unit.

The internal communication I/F 33 is an input/output interface connected to an in-vehicle network (not shown). For example, a communication bus supporting a communication standard such as controller area network (CAN), CAN with Flexible Data-Rate (CAN-FD), or Ethernet (registered trademark) is used for the in-vehicle network. The internal communication I/F 33 performs mutual data communication via the in-vehicle network with in-vehicle equipment such as a vehicle ECU 40 or another relay apparatus. For example, the vehicle ECU 40 is a control apparatus that controls traveling of the vehicle 3, and transmits a vehicle speed, transmission lever position information, and a drive state of a drive source such as an engine of the vehicle 3 to the in-vehicle ECU 300 via the in-vehicle network.

The touch panel 34 includes a display panel such as a liquid-crystal panel or an organic electroluminescent (EL) panel, and a touch sensor. The touch sensor detects a touch operation by the viewer U on the touch panel 34 and outputs position information indicating a position of the detected touch operation to a first control section 330. The touch panel 34 corresponds to an in-vehicle display apparatus.

For example, the speech processing unit 35 includes a processor and converts digital speech data output by the first control section 330 into an analog speech signal. The speech processing unit 35 amplifies the converted analog speech signal and outputs the amplified speech signal via the speaker 36.

The in-vehicle ECU 300 includes an input/output I/F 310 and the first control section 330. The in-vehicle ECU 300 corresponds to a control apparatus.

The input/output I/F 310 functions as a connection unit between the first control section 330 and the external communication I/F 31, the first short-range wireless communication I/F 32, the internal communication I/F 33, the touch panel 34, and the speech processing unit 35. The input/output I/F 310 includes a connector and an interface circuit. The input/output I/F 310 outputs data input from the external communication I/F 31, the first short-range wireless communication I/F 32, the internal communication I/F 33, the touch panel 34, and the speech processing unit 35 to the first control section 330. The input/output I/F 310 outputs data input from the first control section 330 to the external communication I/F 31, the first short-range wireless communication I/F 32, the internal communication I/F 33, the touch panel 34, or the speech processing unit 35.

The first control section 330 is a computer apparatus including a first memory 340 and a first processor 350. The first processor 350 corresponds to a processor.

The first memory 340 includes, for example, a volatile semiconductor memory and a non-volatile semiconductor memory. The first memory 340 may include only a non-volatile semiconductor memory. The first memory 340 may include an auxiliary storage apparatus such as a solid-state drive (SSD). The first memory 340 stores a control program 345 executed by the first processor 350.

### 3. Attachment of Streamer Terminal in Vehicle

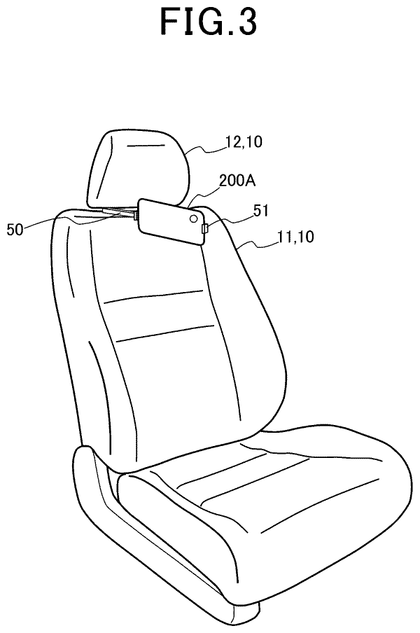

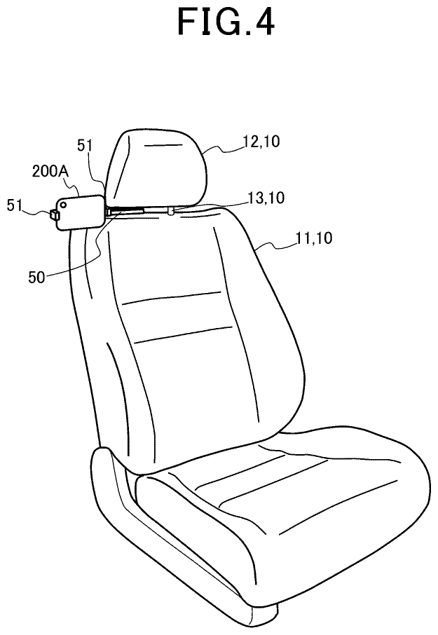

FIGS. 3 and 4 are diagrams showing attachment examples of the streamer terminal 200A in the vehicle 3.

FIGS. 3 and 4 show examples in which the streamer terminal 200A is attached to a passenger seat 10 of the vehicle 3.

The streamer terminal 200A is attached to the seat 10 via an attachment 50. The attachment 50 is attached to a headrest stay 13 that fixes a headrest 12 of the passenger seat 10 to a backrest 11.

FIG. 3 shows an example in which the streamer terminal 200A is attached to the passenger seat 10 so that the streamer S seated in a driver seat is included in an angle of view of the streamer terminal 200A. An attachment position of this streamer terminal 200A is referred to as a first position. FIG. 4 shows an example in which the streamer terminal 200A is attached to the passenger seat 10 so that an area in front of the vehicle 3 is included in the angle of view of the streamer terminal 200A. The attachment position of this streamer terminal 200A is referred to as a second position.

A first holder 51 for fixing the streamer terminal 200A to the attachment 50 is provided at one end portion of the attachment 50 and a second holder for fixing the attachment 50 to the headrest stay 13 is provided at the other end portion of the attachment 50. Illustration of the second holder is omitted. After changing an attachment direction of the attachment 50 to the headrest stay 13, the streamer terminal 200A is attached to the passenger seat 10 in the first position, or the second position by fixing the attachment 50 to the headrest stay 13 via the second holder.

### 4. Configuration of Streaming Server

Next, a configuration of the streaming server 100 will be described.

The streaming server 100 includes a network communication I/F 110 and a second control section 130.

For example, the network communication I/F 110 includes a communication card such as a network interface card (NIC), and performs mutual data communication via the communication network 5 with the in-vehicle apparatus 30, the streamer terminal 200A, and the viewer terminal 200B.

The second control section 130 is a computer apparatus including a second memory 140 and a second processor 150.

The second memory 140 includes, for example, a volatile semiconductor memory and a non-volatile semiconductor memory. The second memory 140 may include only a non-volatile semiconductor memory. The second memory 140 includes an auxiliary storage apparatus such as a hard disk drive (HDD) or an SSD.

The second memory 140 stores a control program 141 executed by the second processor 150, a user information database 143, a stream management database 145, and a content database 147. Hereinafter, database will be abbreviated as DB.

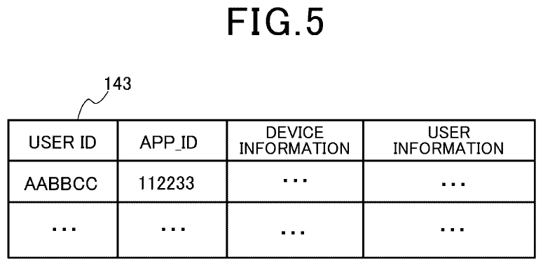

FIG. 5 is a diagram showing a configuration of the user information DB 143.

One record in the user information DB 143 includes a user ID, APP_ID, device information, and user information. APP is an abbreviation of application program.

The user ID is identification information for identifying a user utilizing a streaming service provided by the streaming server 100. The user includes the streamer S and the viewer U.

APP_ID is identification information for identifying an application program downloaded on the streamer terminal 200A or the viewer terminal 200B.

The streamer S and the viewer U download the APP from a predetermined website and respectively install the APP on the streamer terminal 200A and the viewer terminal 200B.

The device information is identification information for identifying the terminal apparatus 200. The device information is, for example, information indicating whether the terminal apparatus 200 is a smartphone, a PC, a head-mounted display apparatus, or a camera. For example, a model number is used for the device information. The device information includes communication information such as an IP address.

The user information is personal information of the streamer S and the viewer U being the user. The user information includes, for example, information such as name, address, sex, and age.

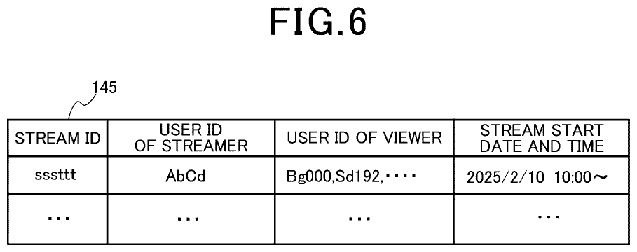

FIG. 6 is a diagram showing a configuration of the stream management DB 145.

One record in the stream management DB 145 includes a stream ID for identifying a stream, the user ID of the streamer S, the user ID of the viewer U, and a stream start date and time.

Returning to FIG. 2, the configuration of the streaming server 100 will be described further.

The second processor 150 is, for example, an arithmetic processing apparatus such as a CPU or an MPU. The second processor 150 may be implemented as a single processor or as a plurality of processors. The second processor 150 may be implemented as an SoC integrated with part or all of the second memory 140, or with another circuit.

### 5. Configuration of Terminal Apparatus

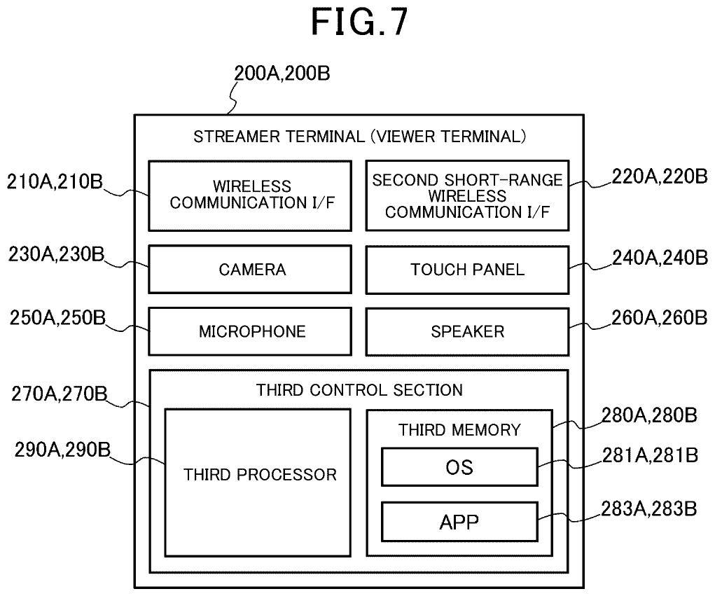

FIG. 7 is a block diagram showing a configuration of the streamer terminal 200A and the viewer terminal 200B. Since the configuration of the streamer terminal 200A and the viewer terminal 200B are substantially the same, description thereof will be based on the configuration of the streamer terminal 200A. In the following description, components of the streamer terminal 200A are denoted with reference sign “A” and components of the viewer terminal 200B are denoted with reference sign “B” for distinction. For example, a third control section 270 included in the streamer terminal 200A is notated as a “third control section 270A” and a third control section 270 included in the viewer terminal 200B is referred to as a “third control section 270B.”

The streamer terminal 200A includes a wireless communication I/F 210A, a second short-range wireless communication I/F 220A, a camera 230A, a touch panel 240A, a microphone 250A, a speaker 260A, and the third control section 270A.

The wireless communication I/F 210A is a communication module that performs wireless communication in accordance with a mobile communication standard such as LTE, 4G, 5G, or Wi-Fi. The wireless communication I/F 210A is connected to the communication network 5 via an antenna (not shown) and performs mutual data transmission/reception with the streaming server 100.

For example, the second short-range wireless communication I/F 220A is a communication module that performs communication in accordance with an NFC standard such as Bluetooth or Wi-Fi. The second short-range wireless communication I/F 220A transmits a captured image captured by the camera 230A, speech input via the microphone 250A, and the like to the in-vehicle apparatus 30 through short-range wireless communication with the in-vehicle apparatus 30.

The camera 230A is a capturing apparatus including an image sensor and a data processing circuit. The image sensor is implemented as, for example, a charge-coupled device (CCD) or a complementary metal-oxide-semiconductor (CMOS). The data processing circuit generates a captured image from an output of the image sensor. The captured image generated by the camera 230A is transmitted to the in-vehicle apparatus 30 under the control of the third control section 270A.

The microphone 250A is a speech input apparatus for inputting speech of the streamer S, and the speaker 260A is a speech output apparatus for outputting speech of the streamer S, the viewer U and the like.

The touch panel 240A includes a display panel such as a liquid-crystal panel or an organic EL panel, and a touch sensor. The touch panel 240A functions as a display part for displaying an image and as a reception part for accepting an operation by the streamer S.

The third control section 270A is a computer apparatus including a third memory 280A and a third processor 290A.

The third memory 280A includes a non-volatile semiconductor memory. The third memory 280A may include an auxiliary storage apparatus such as an SD card. The third memory 280A stores control programs such as an operating system (OS) 281A and an APP 283A. The APP 283A is an application program that performs mutual data communication with the streaming server 100, displays a moving image included in content streamed by the streaming server 100 on the touch panel 240A, and outputs speech included in the content to the speaker 260A.

The third processor 290A is, for example, an arithmetic processing apparatus such as a CPU or an MPU. The third processor 290A may be implemented as a single processor or as a plurality of processors.

### 6. Operation of In-Vehicle Apparatus

Next, an operation of the in-vehicle apparatus 30 will be described.

The first control section 330 of the in-vehicle apparatus 30 is wirelessly connected to the streamer terminal 200A via short-range wireless communication. When the in-vehicle apparatus 30 and the streamer terminal 200A are paired in advance, the in-vehicle apparatus 30 and the streamer terminal 200A are wirelessly connected via short-range wireless communication through the second short-range wireless communication I/F 220A of the streamer terminal 200A being in an operable state and the streamer terminal 200A approaching the vehicle 3 within a predetermined range.

When the streamer terminal 200A is connected via short-range wireless communication, the first control section 330 determines whether the streamer terminal 200A is connected to the attachment 50. The attachment 50 includes a detection part 53 that detects the connection to the streamer terminal 200A. For example, the detection part 53 can be implemented as a physical switch that physically detects the connection of the streamer terminal 200A or a capacitance sensor that detects a change in capacitance and detects the connection between the attachment 50 and the streamer terminal 200A. Upon detecting that the streamer terminal 200A is connected to the attachment 50, the detection part 53 outputs a detection signal to the in-vehicle ECU 300 via the internal communication I/F 33.

The connection between the attachment 50 and the streamer terminal 200A may be determined by acquiring sensor data from a sensor (not shown) included in the streamer terminal 200A. Specifically, the first control section 330 acquires the sensor data from an accelerometer of the streamer terminal 200A in a state in which the in-vehicle apparatus 30 and the streamer terminal 200A are connected via short-range wireless communication. When no change is present in the sensor data of the streamer terminal 200A for a predetermined amount of time or longer, the first control section 330 may determine that the streamer terminal 200A is connected to the attachment 50, based on the acquired sensor data.

A camera that captures an inside of the vehicle 3 may be provided in the vehicle 3. It may be determined whether the attachment 50 and the streamer terminal 200A are connected by performing image analysis on an image captured by this camera.

Upon detecting the connection between the streamer terminal 200A and the attachment 50, the first control section 330 determines whether the vehicle 3 is in a stopped state or a parked state. The first control section 330 displays the captured image captured by the streamer terminal 200A on the touch panel 34, only when the vehicle 3 is in the stopped state or the parked state. The first control section 330 prohibits display of the captured image on the touch panel 34, when the vehicle 3 is in a traveling state.

The determining of whether vehicle 3 is in the stopped state or the parked state is performed based on the vehicle speed acquired by the first control section 330 from the vehicle ECU 40, the transmission lever position information, information indicating the drive state of the drive source such as the engine of the vehicle 3, and the like. For example, the first control section 330 determines that vehicle 3 is in the stopped state or the parked state when the vehicle speed is 0 km and the transmission lever is in the park position. The first control section 330 determines that the vehicle 3 is in the parked state when the engine is in the stopped state and the transmission lever is in the park position.

Upon detecting the connection between the streamer terminal 200A and the attachment 50 and determining that the vehicle 3 is in the stopped state or the parked state, the first control section 330 displays the captured image captured by the streamer terminal 200A on the touch panel 34. At this time, the first control section 330 may acquire information indicating a processing capability of the streamer terminal 200A from the streamer terminal 200A and change a frame rate of the captured image displayed on the touch panel 34 based on the acquired processing capability. Examples of the processing capability of the streamer terminal 200A include the number of cores and clock rate of the third processor 290A. The first control section 330 may change the frame rate of the captured image displayed on the touch panel 34, based on a processing capability, a processing load, and the like of the first processor 350. The processing capability of the first processor 350 includes, for example, clock rate, the number of cores, the number of threads, and cache capacity. The first control section 330 may acquire information indicating a resolution of the touch panel 34 and change the frame rate of the captured image displayed on the touch panel 34 based on the acquired resolution of the touch panel 34.

The first control section 330 may transmit information indicating a processing capability of a third processor included in the first control section 330 to the streamer terminal 200A, and change the frame rate of the captured image displayed by the streamer terminal 200A on the touch panel 34 based on the processing capability of the third processor.

The processing capability of the third processor includes, for example, clock rate, the number of cores, the number of threads, and cache capacity.

Next, the first control section 330 acquires the captured image captured by the camera 230A of the streamer terminal 200A and performs image analysis on the acquired captured image. The first control section 330 performs image analysis on the captured image and detects at least one of the streamer S and vehicle members provided in an interior of the vehicle 3 captured in the captured image. The first control section 330 displays, on the touch panel 34, a guide image 500 for guiding a placement state of the streamer terminal 200A based on at least one of the detected streamer S and vehicle members. The vehicle members detected from the captured image by the first control section 330 include, for example, a window frame and a pillar. For example, when the streamer terminal 200A is placed at the passenger seat 10 as shown in FIG. 3 and the streamer S seated in the driver seat is captured, the first control section 330 detects a window frame at a driver seat side, a B-pillar, and the like. When the streamer terminal 200A is placed at the passenger seat 10 as shown in FIG. 4 and the area in front of the vehicle 3 is captured, the first control section 330 detects a window frame of a windshield, an A-pillar, and the like.

The first control section 330 may store a captured image used during a previous streaming as a reference image in the third memory 280A in advance, and display the guide image 500 based on a position of the streamer S captured in this captured image and a position of the streamer S detected from the current captured image.

An image stored in the first memory 340 in advance may be used as the captured image used as the reference image. This reference image may be downloaded from a server including the streaming server 100, or a manufacturer of the in-vehicle apparatus 30, the vehicle 3, or the like may register this reference image in advance as the reference image in the first memory 340 at the time of shipment of the in-vehicle apparatus 30 or the vehicle 3.

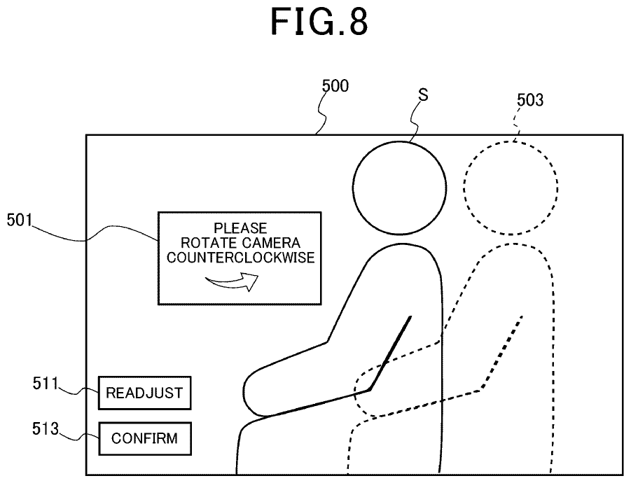

FIG. 8 is a diagram showing an example of a guide image.

Upon detecting the streamer S or the vehicle members, the first control section 330 displays the guide image 500 on the touch panel 34 based on a position of the detected streamer S or vehicle members in the captured image.

For example, the first control section 330 displays the guide image 500 based on a positional relationship between the detected B-pillar or driver seat window frame and the streamer S. In this guide image 500, prompt information 501 for guiding a change direction of an angle of view of the camera 230A may be displayed in text. A contour of the streamer S detected from the captured image used during a past stream may be extracted, and a silhouette image 503 corresponding to the extracted contour may be displayed in the guide image 500.

The guide image 500 includes a readjust button 511 and a confirm button 513. When readjusting the angle of view of the camera 230A of the streamer terminal 200A, the streamer S presses the readjust button 511 after adjusting the placement state of the streamer terminal 200A. When the readjust button 511 is pressed, the first control section 330 performs image analysis on the captured image of the streamer terminal 200A, detects at least one of the streamer S and the vehicle members, and redisplays the prompt information 501, the silhouette image 503, or the like based on a detection result.

Upon determining that angle of view adjustment of the camera 230A of the streamer terminal 200A has ended, the streamer S presses the confirm button 513. The first control section 330 determines that the angle of view adjustment of the camera 230A has ended through the confirm button 513 being pressed, and clears display of the guide image 500.

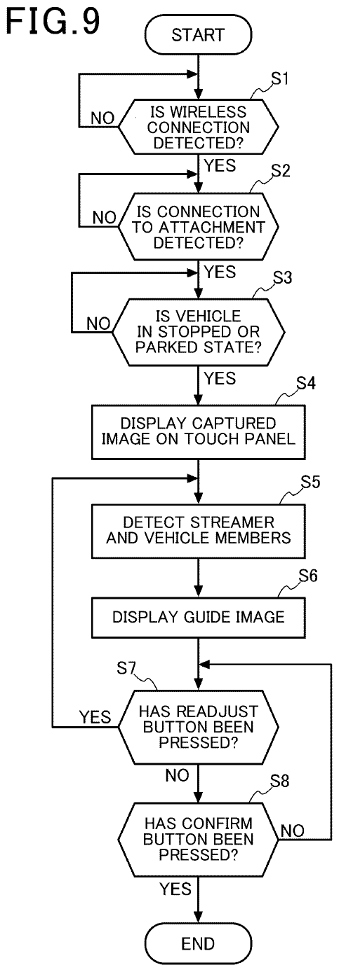

FIG. 9 is a flowchart showing an operation of the in-vehicle apparatus 30.

The operation of the in-vehicle apparatus 30 will be described with reference to the flowchart shown in FIG. 9.

First, the first control section 330 determines whether a wireless connection to the streamer terminal 200A via short-range wireless communication has been detected (step S1). The in-vehicle apparatus 30 and the streamer terminal 200A are wirelessly connected through the streamer terminal 200A approaching the vehicle 3 within the predetermined range. When a wireless connection has not been detected (NO in step S1), the first control section 330 stands by until a wireless connection is detected.

Upon detecting a wireless connection to the streamer terminal 200A via short-range wireless communication (YES in step S1), the first control section 330 determines whether a connection to the attachment 50 has been detected (step S2). The first control section 330 determines that a detection signal has been input from the detection part 53 and determines whether the streamer terminal 200A is connected to the attachment 50.

When a detection signal has not been input from the detection part 53, the first control section 330 determines that a connection to the attachment 50 has not been detected (NO in step S2).

When a detection signal has been input from the detection part 53, the first control section 330 determines that a connection to the attachment 50 has been detected (YES in step S2). Upon detecting the connection to the attachment 50, the first control section 330 determines whether the vehicle 3 is in the stopped state or the parked state (step S3).

The first control section 330 determines whether the vehicle 3 is in the stopped state or the parked state based on the vehicle speed acquired from the vehicle ECU 40, the transmission lever position information, the information indicating the drive state of the drive source such as the engine of the vehicle 3, and the like. When the vehicle 3 is not in the stopped state or the parked state (NO in step S3), the first control section 330 stands by until the vehicle 3 enters the stopped state or the parked state.

When the vehicle 3 is in the stopped state or the parked state (YES in step S3), the first control section 330 displays the captured image captured by the streamer terminal 200A on the touch panel 34 (step S4).

Next, the first control section 330 performs image analysis on the captured image and detects the streamer S, the vehicle members provided in the vehicle 3 such as the pillar or the window frame (step S5). Upon detecting at least one of the streamer S and the vehicle members, the first control section 330 displays the guide image 500 based on the position in the captured image of the at least one of the streamer S and the vehicle members detected (step S6). The first control section 330 may display the guide image 500 based on the position of the streamer S captured in the captured image used during a past stream stored in the third memory 280A and the position of the streamer S detected from the current captured image.

Next, the first control section 330 determines whether the readjust button 511 included in the guide image 500 has been pressed (step S7). When the readjust button 511 has been pressed (YES in step S7), the first control section 330 returns to the processing of step S5 and detects at least one of the streamer S and the vehicle members from the captured image of the streamer terminal 200A.

When the readjust button 511 has not been pressed (NO in step S7), the first control section 330 determines whether the confirm button 513 has been pressed (step S8). When the confirm button 513 has not been pressed (NO in step S8), the first control section 330 returns to the determining of step S7. When the confirm button 513 has been pressed (YES in step S8), the first control section 330 determines that the angle of view adjustment of the camera 230A included in the streamer terminal 200A has ended and ends this processing flow.

### 7. Variations

The above-described embodiment is a preferred embodiment of the present invention. However, the present invention is not limited to the above-described embodiment, and various modifications may be made without departing from the spirit of the present invention.

For example, in the above-described embodiment, a case has been described in which an inside of the vehicle 3 is captured by one streamer terminal 200A, but the inside of the vehicle 3 may be captured by a plurality of streamer terminals 200A.

In the above-described embodiment, a configuration is shown in which the streamer terminal 200A and the in-vehicle apparatus 30 are connected via short-range wireless communication and the captured image is transmitted from the streamer terminal 200A to the in-vehicle apparatus 30, but the streamer terminal 200A may upload the captured image to the streaming server 100 and the streaming server 100 may upload the captured image to the in-vehicle apparatus 30. The streamer S visually recognizes a preview image of the captured image displayed on the touch panel 34 of the in-vehicle apparatus 30 and adjusts the angle of view of the streamer terminal 200A being the capturing apparatus.

The streamer terminal 200A may function as the in-vehicle apparatus 30. That is, the captured image captured by the streamer terminal 200A may be transmitted to the streaming server 100 without passing through the in-vehicle apparatus 30.

In the above-described embodiment, a case has been described in which the in-vehicle apparatus 30 displays the guide image 500 on the touch panel 34 being the in-vehicle display apparatus included in the in-vehicle apparatus 30, but the guide image 500 may also be displayed on another terminal apparatus 200 brought in the vehicle 3 by the streamer S.

At this time as well, the first control section 330 may acquire the information indicating the processing capability of the streamer terminal 200A from the streamer terminal 200A and change the frame rate of the captured image displayed on the touch panel 34 based on the acquired processing capability. The first control section 330 may change the frame rate of the captured image displayed on the touch panel 34, based on the processing capability, the processing load, and the like of the first processor 350. Furthermore, the first control section 330 may acquire the information indicating the resolution of the touch panel 34 and change the frame rate of the captured image displayed on the touch panel 34 based on the acquired resolution of the touch panel 34.

The processing units in the flowchart shown in FIG. 9 are divided in accordance with their main processing content to facilitate understanding of the processing performed by the in-vehicle apparatus 30. The present invention is not limited by the manner in which the processing units in the flowchart of FIG. 9 are divided or by the names assigned to those processing units. The processing performed by the in-vehicle apparatus 30 can be divided into a greater number of processing units in accordance with the processing content, or can be divided so that one processing unit includes a greater amount of processing. The order of the processing in the above flowchart is not limited to the example shown in the figure.

### 8. Configurations Supported by the Above Embodiment

The above embodiment supports the following configurations.

### Configuration 1

A vehicle including: an in-vehicle display apparatus; and a control apparatus configured to acquire a captured image captured by a capturing apparatus and display the acquired captured image on the in-vehicle display apparatus, wherein the control apparatus displays, on the in-vehicle display apparatus, a guide image for guiding placement of the capturing apparatus in the vehicle based on the captured image.

According to the vehicle of configuration 1, the control apparatus displays, on the in-vehicle display apparatus, the guide image for guiding placement of the capturing apparatus in the vehicle based on the captured image. Accordingly, it is possible for a user to place the capturing apparatus in the vehicle while referencing the guide image displayed on the in-vehicle display apparatus, to simplify placement work of the capturing apparatus, and to enhance user-friendliness.

### Configuration 2

The vehicle according to configuration 1, wherein the control apparatus: detects at least one of a person and a member installed in an interior of the vehicle from the captured image; and displays, on the in-vehicle display apparatus, the guide image based on a position in the captured image of the at least one of the person and the member detected.

According to the vehicle of configuration 2, the control apparatus detects at least one of the person and the member installed in the interior of the vehicle from the captured image, and displays the guide image based on the position in the captured image of the at least one of the person and the member detected. Accordingly, it is possible to enhance reproducibility of an angle of view of the capturing apparatus when placing the capturing apparatus in the vehicle.

### Configuration 3

The vehicle according to configuration 1, wherein the capturing apparatus is retained by an in-vehicle retainer configured to fix the capturing apparatus to the vehicle, and in a state in which a connection between the capturing apparatus and the in-vehicle retainer has been detected previously, the control apparatus sets, as a reference image, the captured image acquired from the capturing apparatus or the captured image stored in advance in a storage unit included in the control apparatus, and displays the guide image on the in-vehicle display apparatus based on a comparison result between the reference image and the captured image.

According to the vehicle of configuration 3, in the state in which the connection between the capturing apparatus and the in-vehicle retainer has been detected previously, the captured image acquired from the capturing apparatus or the captured image stored in advance in the storage unit is set as the reference image, and the guide image is displayed on the in-vehicle display apparatus based on the comparison result between this reference image and the captured image. Accordingly, it is possible to enhance reproducibility of the angle of view of the capturing apparatus when placing the capturing apparatus in the vehicle.

### Configuration 4

The vehicle according to configuration 1, wherein the control apparatus: acquires, from a control apparatus of the vehicle, information indicating whether the vehicle is in a traveling state; and prohibits display of the guide image on the in-vehicle display apparatus, when determining that the vehicle is in the traveling state using the acquired information.

According to the vehicle of configuration 4, the control apparatus acquires, from the control apparatus of the vehicle, the information indicating whether the vehicle is in the traveling state, and prohibits display of the guide image on the in-vehicle display apparatus when the vehicle is in the traveling state based on the acquired information. Accordingly, it is possible to suppress having to perform angle of view adjustment of the capturing apparatus when the vehicle is traveling, since the guide image is not displayed on the in-vehicle display apparatus when the vehicle is traveling.

### Configuration 5

The vehicle according to configuration 1, wherein the capturing apparatus is retained by an in-vehicle retainer configured to fix the capturing apparatus to the vehicle, the vehicle further includes a detection part configured to detect a connection between the capturing apparatus and the in-vehicle retainer, and the control apparatus displays, on the in-vehicle display apparatus, the captured image captured by the capturing apparatus, when the connection between the capturing apparatus and the in-vehicle retainer is detected by the detection part.

According to the vehicle of configuration 5, the captured image captured by the capturing apparatus is displayed on the in-vehicle display apparatus, when the connection between the capturing apparatus and the in-vehicle retainer is detected. Accordingly, it is possible to display the captured image captured by the capturing apparatus on the in-vehicle display apparatus by connecting the capturing apparatus to the in-vehicle retainer, to reduce the effort needed for user operations, and to enhance user-friendliness.

### Configuration 6

The vehicle according to configuration 1, further including a wireless communication unit configured to wirelessly connect to a display apparatus, wherein the control apparatus transmits the captured image acquired from the capturing apparatus to the in-vehicle display apparatus via the wireless communication unit, and the control apparatus changes a frame rate of the captured image transmitted to the in-vehicle display apparatus, based on at least any one of a processing capability of the capturing apparatus, a processing load of the control apparatus, and a processing capability of the control apparatus.

According to the vehicle of configuration 6, the frame rate of the captured image transmitted to the in-vehicle display apparatus is changed based on at least any one of the processing capability of the capturing apparatus, the processing load of the control apparatus, and the processing capability of the control apparatus. Accordingly, it is possible to display the captured image captured by the capturing apparatus on the in-vehicle display apparatus while suppressing an increase in the processing load of the capturing apparatus, the control apparatus, and the like.

### Configuration 7

The vehicle according to configuration 1, wherein the control apparatus: acquires a processing capability of the capturing apparatus or a resolution of the in-vehicle display apparatus; and changes a frame rate of the captured image displayed on the in-vehicle display apparatus, based on the processing capability of the capturing apparatus or the resolution of the in-vehicle display apparatus acquired.

According to the vehicle of configuration 7, the frame rate of the captured image displayed on the in-vehicle display apparatus is changed based on the processing capability of the capturing apparatus or the resolution of the in-vehicle display apparatus. Accordingly, it is possible to display the captured image displayed on the in-vehicle display apparatus while suppressing an increase in the processing load.

### Configuration 8

A placement method for a capturing apparatus, the placement method causing a processor installed in a vehicle to execute: acquiring a captured image captured by a capturing apparatus; displaying the acquired captured image on an in-vehicle display apparatus installed in the vehicle; and displaying, on the in-vehicle display apparatus, a guide image for guiding placement of the capturing apparatus in the vehicle based on the captured image.

According to the placement method for a capturing apparatus of configuration 8, it is possible to achieve the same effects as the vehicle of configuration 1.

### Configuration 9

A non-transitory computer-readable storage medium storing a program for causing a computer installed in a vehicle to execute: acquiring a captured image captured by a capturing apparatus; displaying the acquired captured image on an in-vehicle display apparatus installed in the vehicle; and displaying, on the in-vehicle display apparatus, a guide image for guiding placement of the capturing apparatus in the vehicle based on the captured image.

According to the program of configuration 9, it is possible to achieve the same effects as the vehicle of configuration 1.

### REFERENCE SIGNS LIST

1 streaming system
3 vehicle
5 communication network
10 seat
11 backrest
12 headrest
13 headrest stay
30 in-vehicle apparatus
31 external communication interface
32 first short-range wireless communication interface
33 internal communication interface
34 touch panel
35 speech processing unit
36 speaker
40 vehicle ECU
50 attachment
51 first holder
53 detection part
100 streaming server
110 network communication I/F
130 second control section
140 second memory
141 control program
143 user information database
145 stream management database
147 content database
150 second processor
200 terminal apparatus
200A streamer terminal
200B viewer terminal
210A wireless communication I/F
220A second short-range wireless communication interface I/F
230A camera
240A touch panel
250A microphone
260A speaker
270A third control section
280A third memory
281A OS
283A APP
290A third processor
300 in-vehicle ECU
310 input/output I/F
330 first control section
340 first memory
350 first processor
500 guide image
501 prompt information
503 silhouette image
511 readjust button
513 confirm button

1. A vehicle comprising:
an in-vehicle display apparatus; and
a control apparatus configured to acquire a captured image captured by a capturing apparatus and display the acquired captured image on the in-vehicle display apparatus, wherein
the control apparatus displays, on the in-vehicle display apparatus, a guide image for guiding placement of the capturing apparatus in the vehicle based on the captured image.

2. The vehicle according to claim 1, wherein
the control apparatus:
detects at least one of a person and a member installed in an interior of the vehicle from the captured image; and
displays, on the in-vehicle display apparatus, the guide image based on a position in the captured image of the at least one of the person and the member detected.

3. The vehicle according to claim 1, wherein
the capturing apparatus is retained by an in-vehicle retainer configured to fix the capturing apparatus to the vehicle, and
in a state in which a connection between the capturing apparatus and the in-vehicle retainer has been detected previously, the control apparatus sets, as a reference image, the captured image acquired from the capturing apparatus or the captured image stored in advance in a storage unit included in the control apparatus, and displays the guide image on the in-vehicle display apparatus based on a comparison result between the reference image and the captured image.

4. The vehicle according to claim 1, wherein
the control apparatus:
acquires, from a control apparatus of the vehicle, information indicating whether the vehicle is in a traveling state; and
prohibits display of the guide image on the in-vehicle display apparatus, when determining that the vehicle is in the traveling state using the acquired information.

5. The vehicle according to claim 1, wherein
the capturing apparatus is retained by an in-vehicle retainer configured to fix the capturing apparatus to the vehicle,
the vehicle further comprises a detection part configured to detect a connection between the capturing apparatus and the in-vehicle retainer, and
the control apparatus displays, on the in-vehicle display apparatus, the captured image captured by the capturing apparatus, when the connection between the capturing apparatus and the in-vehicle retainer is detected by the detection part.

6. The vehicle according to claim 1, further comprising a wireless communication unit configured to wirelessly connect to a display apparatus, wherein
the control apparatus transmits the captured image acquired from the capturing apparatus to the in-vehicle display apparatus via the wireless communication unit, and
the control apparatus changes a frame rate of the captured image transmitted to the in-vehicle display apparatus, based on at least any one of a processing capability of the capturing apparatus, a processing load of the control apparatus, and a processing capability of the control apparatus.

7. The vehicle according to claim 1, wherein
the control apparatus:
acquires a processing capability of the capturing apparatus or a resolution of the in-vehicle display apparatus; and
changes a frame rate of the captured image displayed on the in-vehicle display apparatus, based on the processing capability of the capturing apparatus or the resolution of the in-vehicle display apparatus acquired.

8. A placement method for a capturing apparatus, the placement method causing a processor installed in a vehicle to execute:
acquiring a captured image captured by a capturing apparatus;
displaying the acquired captured image on an in-vehicle display apparatus installed in the vehicle; and
displaying, on the in-vehicle display apparatus, a guide image for guiding placement of the capturing apparatus in the vehicle based on the captured image.

9. A non-transitory computer-readable storage medium storing a program for causing a computer installed in a vehicle to execute:
acquiring a captured image captured by a capturing apparatus;
displaying the acquired captured image on an in-vehicle display apparatus installed in the vehicle; and
displaying, on the in-vehicle display apparatus, a guide image for guiding placement of the capturing apparatus in the vehicle based on the captured image.
